(19) United States
(12) Patent Application Publication
(10) Pub. No.: US 2008/0142588 A1
(43) Pub. Date: Jun. 19, 2008

(54) RFID Access Control Intercommunication

(75) Inventor: Remi David BLUM, Holon (IL)

Correspondence Address: SIMON KAHN - PYI Tech, Ltd.;c/o LANDONIP, INC, 1700 DIAGONAL ROAD, SUITE 450, ALEXANDRIA, VA, 22314-2866, US

(73) Assignee: IMMOTEC SECURITY SYSTEMS, LTD., Holon (IL)

(21) Appl. No.: 11/951,413

(22) Filed: Dec. 6, 2007

Related U.S. Application Data
(60) Provisional application No. 60/869,732, filed on Dec. 13, 2006.

(51) Int. Cl. G06K 7/01

(52) U.S. Cl. 235/382.5

(57) ABSTRACT

An access control system comprising: a primary contactless read write device; at least one secondary contactless read write device; and a plurality of smart cards configured for use with the primary contactless read write device and the at least one secondary contactless read write device, the plurality of smart cards being further configured to exhibit a temporary storage space for use by one of the primary contactless read write device and the at least one secondary contactless read write device.

### CROSS-REFERENCE TO RELATED APPLICATIONS

This application claims priority from U.S. Provisional Patent Application Ser. No. 60/869,732 filed Dec. 13, 2006, entitled “RFID Access Control Intercommunication”, the entire contents of which is incorporated herein by reference.

### BACKGROUND OF THE INVENTION

The invention relates generally to the field of proximity access control and in particular to a method for transferring information between a primary read write device and at least one secondary read write device.

Contactless smart cards are often used for controlled access applications and operate via radio frequency identification, or RFID, and are covered under a number of international standards such as ISO 14443 and ISO 15693 published by the International Organization for Standardization, Geneva, Switzerland the entire contents of both of which are incorporated herein by reference. Contactless smart cards for controlled access applications are often called contactless smart cards, and are typically encased in plastic and with a visual image of the authorized user embedded on one face. ISO 14443 defines proximity cards and ISO 15693 define vicinity cards, with the major difference being that vicinity cards may be further removed from a read write device than proximity cards. For the purposes of this document, the term proximity means within an active distance of the read write device, i.e. a distance over which the smart card can be accessed, irrespective of whether the actual distance corresponds to proximity according to ISO 14443 or vicinity according to ISO 15693.

Contactless smart cards thus find application in controlled access of high security installations comprising a primary read write device (RWD), typically controlled and supervised by security personnel, and additional RWDs, denoted secondary RWDs. The secondary RWDs, which in certain embodiments are not in communication with the primary RWD, are spread throughout the premises further controlling access in accordance with a set of predefined security rules. The set of primary and secondary RWDs define a security system, however in the absence of communication between the primary and secondary RWDs certain difficulties arise. The lack of communication may be intentional to prevent hacking, or as a result of difficulties in arranging for the interconnection of the various RWDs with a central host.

The lack of communication between the primary and secondary RWDs results in a situation where updated information regarding authorized contactless smart cards is not easily transferred to all secondary RWDs. For example, in the event of a lost contactless smart card, a replacement contactless smart card may be issued at the primary RWD, however the secondary RWDs may not be aware of the invalidation of the lost contactless smart card, or the validity of the newly issued contactless smart card.

An additional difficulty may arise in the event the security system relies in any manner on maintaining an accurate time of day log. In one example access to certain areas may be restricted to predetermined times, and in another example access to certain highly restricted areas may be restricted to being within a predetermined time lapse from authorized access from a less restricted area. There is however great difficulty in updating the time of secondary RWDs, and thus the changeover to, or from, daylight savings time may result in unintentionally denied access.

A further difficulty is the inability to maintain a centralized record of all access events, since the secondary RWDs have no means of communicating access events to the host or primary RWD.

There is thus a long felt need for an improved controlled access system providing a means for transferring information, outside of a network connection, between a primary RWD and at least one secondary RWD.

### SUMMARY OF THE INVENTION

Accordingly, it is a principal object of the present invention to overcome the disadvantages of prior art controlled access systems. This is provided in the present invention by storing transfer information on each of the contactless smart cards as the contactless smart card is placed in proximity of the RWD. In one embodiment, each secondary RWD maintains a local stack of historical access events. Each contactless smart card, when placed in proximity of a secondary RWD, is loaded with a pre-determined number of most recent historical events, and an identifier of the secondary RWD. When the contactless smart card is placed in proximity of the primary RWD, the historical access events and the identifier of the secondary RWD which was the source of the access events, is loaded to the primary RWD. The access event memory is then erased from the contactless smart card. The primary RWD, in cooperation with the identifier of the secondary RWD, prevents duplication of records, and thus stores a complete event listing of all RWDs in the system. In one embodiment the primary RWD stores the complete event listing locally, and in another embodiment he complete event listing is stored on a connected database. In yet another embodiment the primary RWD uploads data for permanent remote storage via a dedicated transfer contactless smart card or portable computer.

In another embodiment, which finds particular advantage during the change to, or from, daylight savings time, in the event of a change in time at the primary RWD, each contactless smart card when placed in proximity to the primary RWD for a predetermined time period is loaded with information to adjust the clock by a particular amount of time. When the contactless smart card is placed in proximity of any of the secondary RWDs, the secondary RWD reads the time adjustment, and adjusts its internal clock accordingly.

In another embodiment, security is enhanced by time stamping the contactless smart card when it is in proximity to the main RWD. Access to secondary RWDs are restricted to being with a predetermined time period of the time stamp. Thus, in the event of a lost contactless smart card, access will be denied.

In one embodiment the invention provides for an access control system comprising: a primary contactless read write device; at least one secondary contactless read write device; and a plurality of smart cards configured for use with the primary contactless read write device and the at least one secondary contactless read write device, the plurality of smart cards being further configured to exhibit a temporary storage space for use by one of the primary contactless read write device and the at least one secondary contactless read write device.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates an embodiment of a security system supporting controlled access in accordance with a principle of the invention, the security system comprising a primary RWD and at least one secondary RWD;

FIG. 2A illustrates a high level schematic diagram of a smart card in accordance with a principle of the invention, comprising a configurable memory with a predetermined configuration area, general memory area and a temporary storage area;

FIG. 2B illustrates a high level block diagram of the configuration area of FIG. 2A, exhibiting a configuration card identifier, a transfer card identifier, an access card identifier and a single access card identifier, in accordance with a principle of the invention;

FIG. 3A illustrates a high level flow chart of the operation of each of the secondary RWDs of the system of FIG. 1 to maintain a stack of historical access events, and upload a predetermined number of most recent access events to a smart card in accordance with a principle of the invention;

FIG. 3B illustrates a high level flow chart of the operation of the primary RWD of the system of FIG. 1 to download the transferred access events of FIG. 3A and a maintain a complete database of entry events in accordance with a principle of the invention;

FIG. 4A illustrates a high level flow chart of the operation of the primary RWD of the system of FIG. 1 to transfer clock update information to each of the secondary RWDs via smart cards in accordance with a principle of the invention;

FIG. 4B illustrates a high level flow chart of the operation of the secondary RWDs of the system of FIG. 1 to receive clock update information from the primary RWD via a smart card and update the local clock, in accordance with a principle of the invention;

FIG. 5A illustrates a high level flow chart of the operation of the primary RWD of the system of FIG. 1 to authorize access and time stamp each smart card in accordance with a principle of the invention;

FIG. 5B illustrates a high level flow chart of the operation of the secondary RWDs of the system of FIG. 1 to control access responsive to the stored time stamp of FIG. 5A in accordance with a principle of the invention; and

FIG. 5C illustrates a high level flow chart of the operation of both the primary and secondary RWDs of the system of FIG. 1 to control access and identify a lost smart card responsive to a creation date/time stamp.

### DETAILED DESCRIPTION OF THE PREFERRED EMBODIMENTS

The present embodiments enable an improved access control system by storing transfer information on each of the contactless smart cards as the contactless smart card is placed in proximity of the RWD. In one embodiment, each secondary RWD maintains a local stack of historical access events. Each contactless smart card, when placed in proximity of a secondary RWD is loaded a pre-determined number of most recent historical events and an identifier of the secondary RWD. When the contactless smart card is placed in proximity of the primary RWD, the historical access events and the identifier of the secondary RWD which was the source of the access events, is loaded to the primary RWD. The access event memory is then erased from the contactless smart card. The primary RWD, in cooperation with the identifier of the secondary RWD, prevents duplication of records, and thus stores a complete event listing of all RWDs in the system. In one embodiment the primary RWD stores the complete event listing locally, and in another embodiment the complete event listing is stored on a connected database. In yet another embodiment the primary RWD uploads data for permanent remote storage via a dedicated transfer contactless smart card or portable computer.

In another embodiment, which finds particular advantage during the change to, or from, daylight savings time, in the event of a change in time at the primary RWD, each contactless smart card when placed in proximity to the primary RWD for a predetermined time period is loaded with information to adjust the clock by a particular amount of time. When the contactless smart card is placed in proximity of any of the secondary RWDs, the secondary RWD reads the time adjustment, and adjusts its internal clock accordingly.

In another embodiment, security is enhanced by time stamping the contactless smart card when it is in proximity to the main RWD. Access to secondary RWDs are restricted to being with a predetermined time period of the time stamp. Thus, in the event of a lost contactless smart card, access will be denied.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

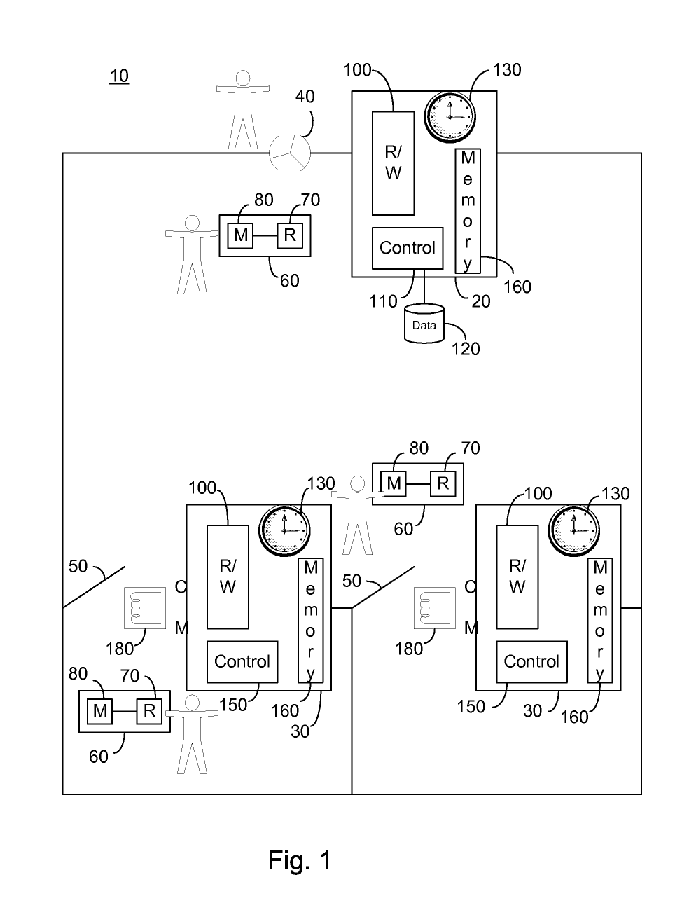

FIG. 1 illustrates an embodiment of a security system 10 supporting controlled access in accordance with a principle of the invention, the security system comprising: a primary RWD 20; at least one secondary RWD 30; a main electronically controlled access 40; at least one secondary controlled access 50; a plurality of smart cards 60 illustrated as being held by individual personnel and a data base storage 120. Each of the smart cards 60 comprise read/write electronics 70 and a configurable memory 80. Primary RWD 20 comprises a contactless card reader/writer circuitry 100, a control circuitry 110, a memory 160 and a date/time clock 130. Each secondary RWD 30 comprises a contactless card reader/writer circuitry 100, a control circuitry 150, a memory 160 and a date/time clock 130. Control circuitry 110 of primary RWD 20 is connected to contactless card reader/writer circuitry 100, database storage 120, date/time clock 130 and electronically controlled access 40. Control circuitry 150 of each secondary RWD 30 is connected to contactless card reader stroke writer circuitry 100, memory 160 and date/time time clock 130. Each secondary controlled access 50 comprises an electronically controlled switch 180 connected to the respective control circuitry 150 of secondary RWD 30.

The above has been described in embodiment in which a primary RWD 20 comprises a local memory 160 and is connected externally to a data base storage 120 however this is not meant to be limiting in any way. In an alternative embodiment data base storage 120 is internal to primary RWD 20. In yet another embodiment, database storage 120 is not coincident with primary RWD 20, and data is uploaded from local memory 160 to a dedicated transfer contactless smart card or a portable computer for transfer to a remote database or storage.

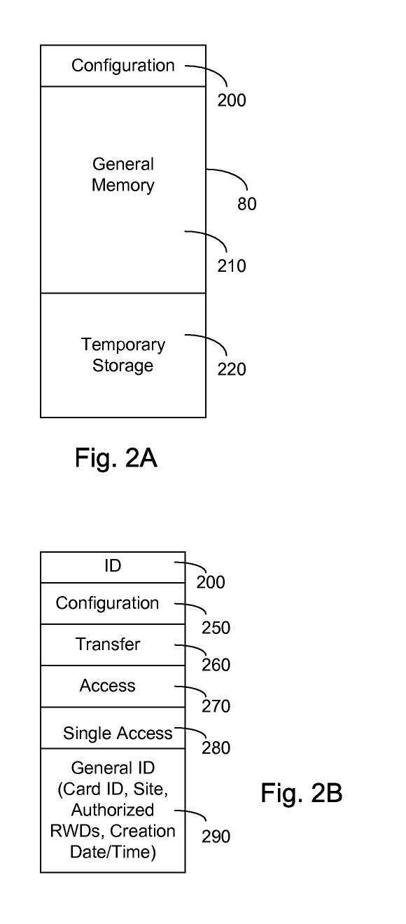

FIG. 2A illustrates the high-level block diagram of configurable memory 80 of contactless smart card 60 in accordance with a principle of the invention, comprising a configuration area 200, a general memory area 210 and a temporary storage location 220. Read/write electronics 70 is operative to store data on any of configuration area 200, general memory area 210 and temporary storage location 220 responsive to appropriate commands comprising the appropriate address. Configuration area 200 comprises a contactless smart card ID, as will be explained further hereinto below, the contactless smart card ID comprising: a site number; a contactless smart card number; a list of RWD IDs authorized for access; and a date/time stamp of creation of the contactless smart card.

In operation, in the event that any contactless smart card 60 is placed within proximity of contactless card reader/writer circuitry 100, respective control circuitry 110, 150 is operative to detect contactless smart card 60 and read an identification number stored thereon.

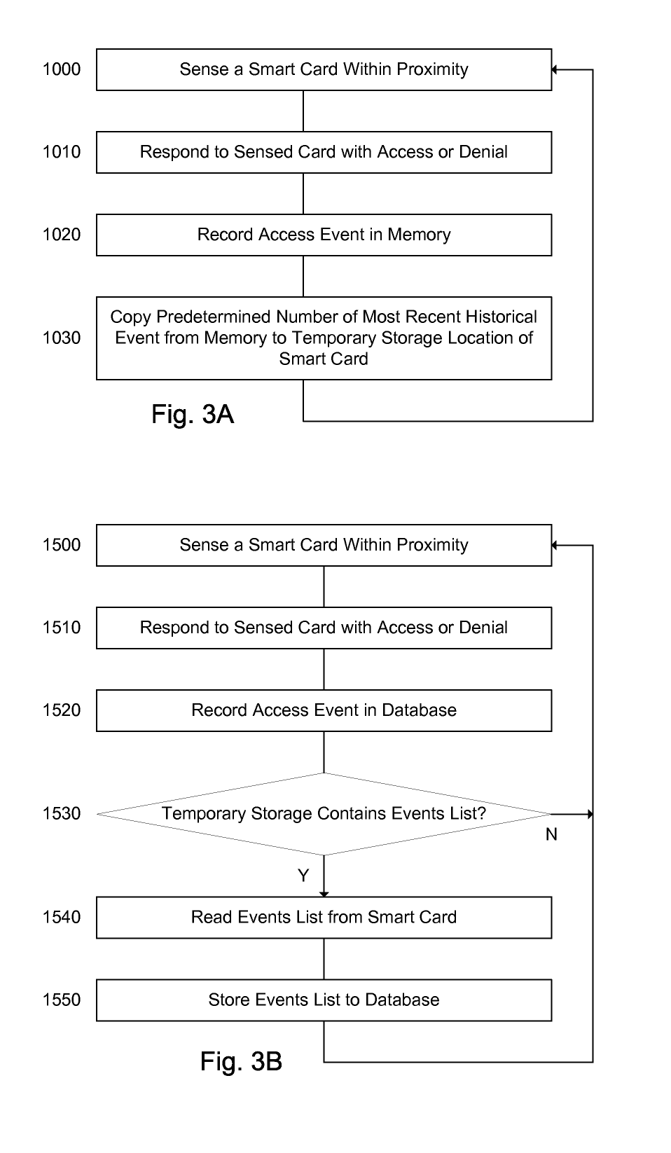

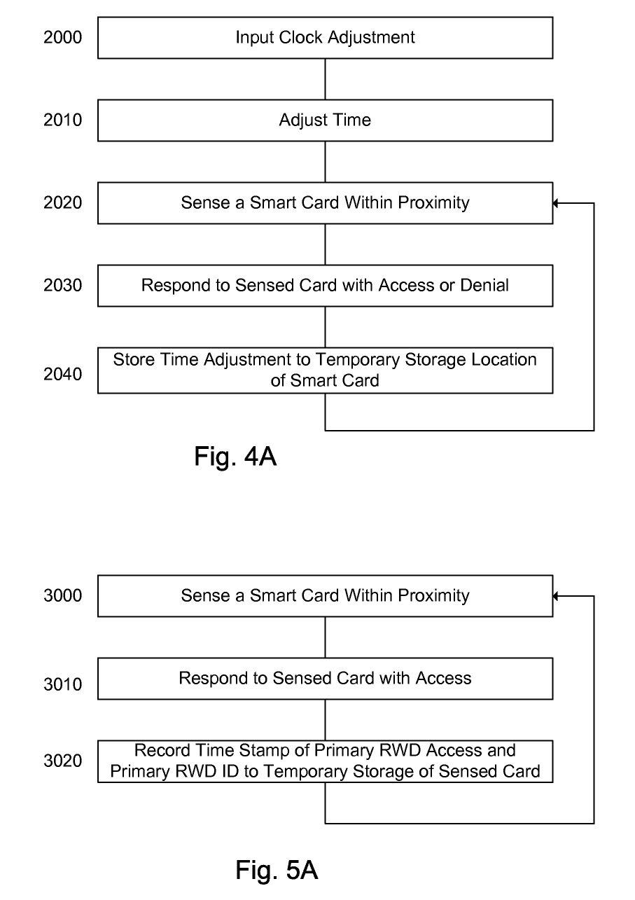

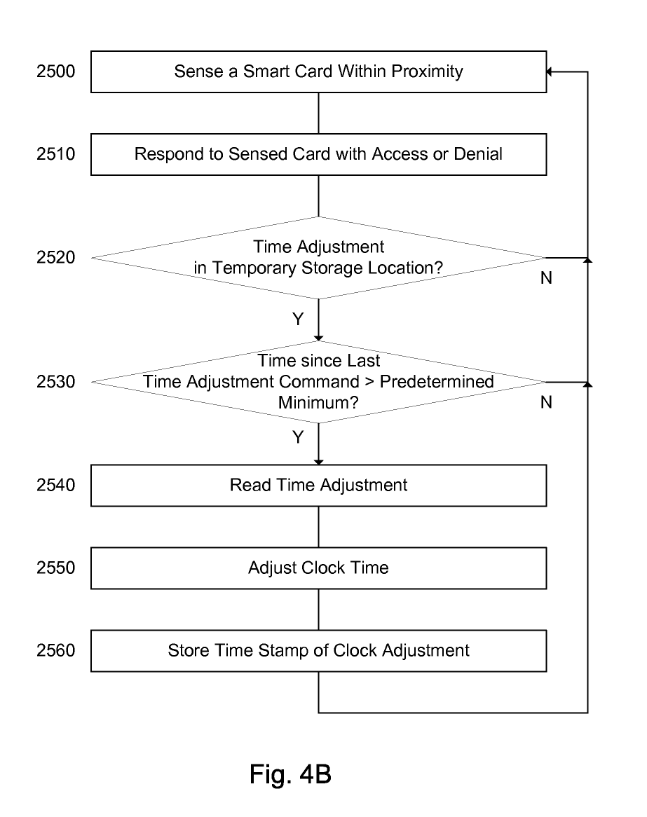

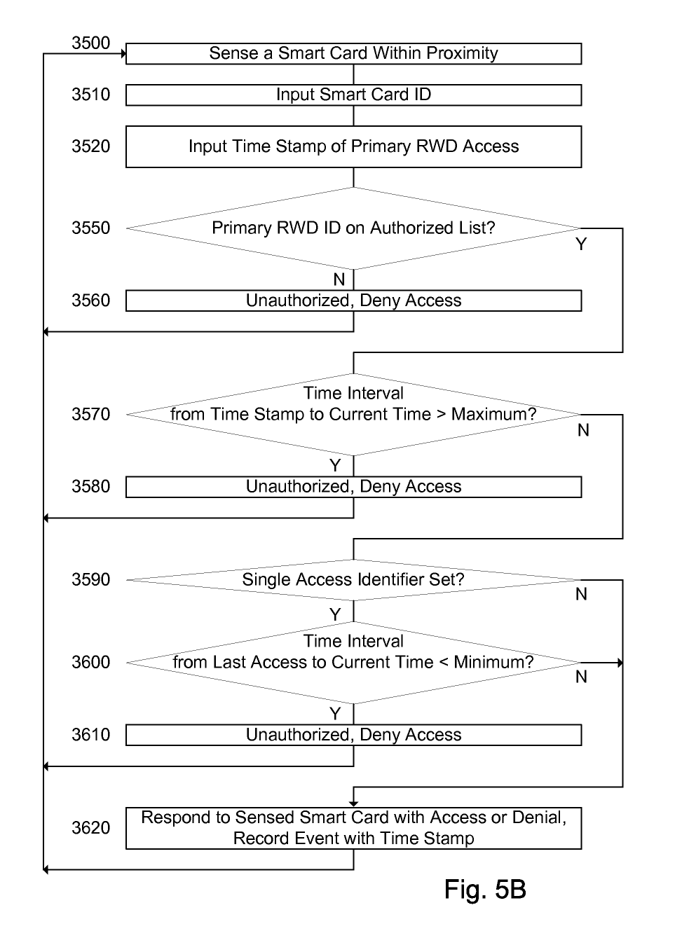

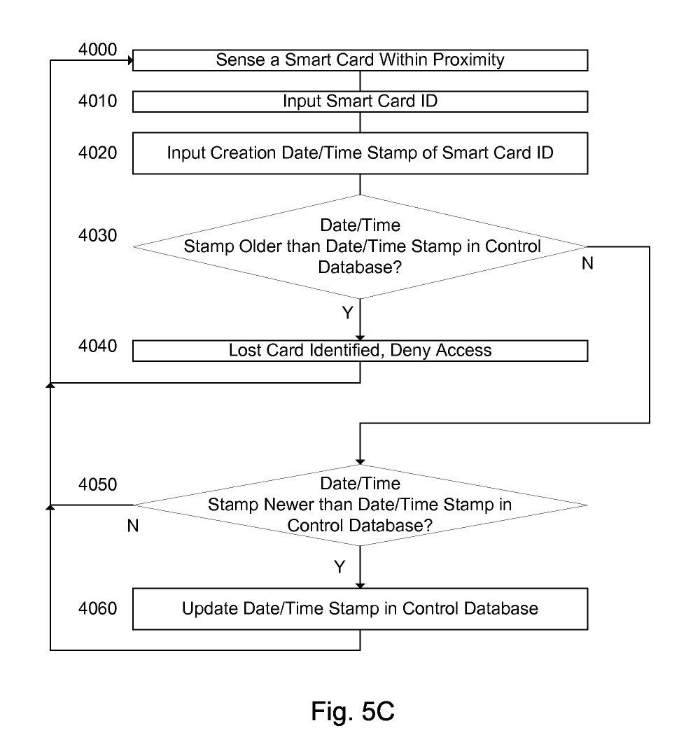

In the event that a particular contactless smart card 60 is within proximity of primary RWD 20, control circuitry 110 compares the contactless smart card ID, and in particular the site number and list of RWD IDs authorized for access with the site number and ID of primary RWD 20. In the event that the site number and primary RWD 20 ID match the site number and authorized RWD ID list on the particular contactless smart card 60, control circuitry 110 operates main electronically controlled access 40 to enable entry. Control circuitry 110 further stores the authorized access event, together with a date/time stamp on local memory 160. In one embodiment, as described further below in relation to FIG. 3B, control circuitry 110 inputs an event list from temporary storage area 220 of configurable memory 80, stores the event list in local memory 160 and erases temporary storage area 220. In another embodiment, as described further below in relation to FIG. 4A, control circuitry 110 loads into a temporary storage area 220 a clock adjustment, the clock adjustment being utilized by secondary RWD and 30 update the respective date/time clock 130. In another embodiment, as we described further below in relation to FIG. 5A, control circuitry 110 further stores the current date/time stamp, together with an ID number of primary RWD 20 in general memory area 210 of configurable memory 80.

In the event that a particular contactless smart card 60 is within proximity of a secondary RWD 30, control circuitry 150 compares the contactless smart card ID, and in particular the site number and list of RWD IDs authorized for access with the site number and ID of secondary RWD 30. In the event that the site number and secondary RWD 30 ID match the site number and authorized RWD ID list on the particular contactless smart card 60, control circuitry 150 operates electronically controlled switch 180 of secondary electronically controlled access 50 to enable entry and stores the authorized access event, together with a date/time stamp on memory 160. In a preferred embodiment the access event is stored with the contactless smart card number, the type of event, the RWD number, the site number and the date/time stamp. In one embodiment, as will be described further hereinto below in relation to FIG. 3A, control circuitry 150 further copies a predetermined number of most recent stored access events to temporary storage area 220 together with an identifier of secondary RW 30. In another embodiment, as described further below in relation to FIG. 4B, control circuitry 150 further reads a stored clock adjustment from temporary storage area 220, and utilizes the clock adjustment to adjust the time of date/time clock 130.

In another embodiment, as will be described further below in relation to FIG. 5B, the creation date/time stamp, stored in configuration area 200, is compared with a last access event with the ID number of contactless smart card 60 to identify a lost card. In yet another embodiment, as will be described further below in relation to FIG. 5B, access is only allowed to secondary electronically controlled access 50 within a predetermined time period of an enabled access through main electronically controlled access 40. Thus, the date/time stamp stored in general memory area 210 is compared with current time as indicated by date/time clock 130 to confirm that time elapsed is less than a maximum allowed. In yet another embodiment, as will be described further below in relation to FIG. 5B, only a single access is allowed within a predetermined time in, and the current time as indicated by date/time clock 130 is compare with a last event time associated with the particular contactless smart card 60 stored in memory 160 to ensure only a single access during the predetermined time period.

FIG. 2B illustrates a high level block diagram of configuration area 200 of FIG. 2A, exhibiting a configuration card identifier 250, a transfer card identifier 260, an access card identifier 270, a single access card identifier 270 and a general ID area 290, in accordance with a principle of the invention. In one embodiment each of configuration card identifier 250, transfer card identifier 260, access card identifier 270 and single access card identifier 280 represent a single bit which may be set or not set under control of primary RWD 20. In another embodiment a single byte indicative of the settings of the card type and/or access type is used.

In the event that configuration card identifier 250 is set, a secondary RWD 30 will identify the contactless smart card 60 as being a configuration card. The contactless smart card 60 will thus not enable access, and the contents of general memory area 210 and/or temporary storage area 220 will be utilized to configure secondary RWD 30.

In the event that dedicated transfer card identifier 260 is set, a secondary RWD 30 will identify the smart card as being a transfer card. The contactless smart card 60 with thus not enable access and the contents of memory 160 will be loaded into one of general memory area 210 and/or temporary storage area 220. Alternatively, based on a bit setting on contactless smart card 60, the contents of one of general memory area 210 and/or temporary storage area 220 are loaded from a contactless smart card 60 to local memory 160. Additionally, primary RWD 20 is operative to copy the contents of memory 160 to general memory location 210 and/or temporary storage area 220. Thus, a contactless smart card is used as a temporary or permanent storage means.

In the event that access card identifier 270 is set, both primary RWD 20 and secondary RWD 30 will operate as described further hereinto below in relation to FIGS. 3A-5B to enable access and transfer data as required between primary RWD 20 and secondary RWD 30.

In the event that single access identifier 280 is set, secondary RWD 30 will act as described below in relation to FIG. 5B to only allow a single access within a predetermined time period from access to primary RWD 30.

General ID area 290 contains the contactless smart card ID comprising: a site number; a contactless smart card number; a list of RWD IDs authorized for access; and a date/time stamp of creation of the contactless smart card,

FIG. 3A illustrates a high level flow chart of the operation of each secondary RWD 30 of system 10 to maintain a stack of historical access events on memory 160, and upload a predetermined number of most recent access events from the stack of memory 160 to a contactless smart card 60 in accordance with a principle of the invention. In stage 1000, control circuitry 150 of secondary RWD 30 senses a contactless smart card 60 within proximity thereof. In stage 1010 control circuitry 150 of secondary RWD 30 compares the contactless smart card ID, and in particular the site number and list of RWD IDs authorized for access with the site number and ID of secondary RWD 30. As described above, authorized ID numbers may be loaded directly into secondary RWD 30, or transferred via a transfer card identified by transfer card identifier 260 being set.

In the event that the site number and secondary RWD 30 ID match the site number and authorized RWD ID list on the particular contactless smart card 60, access is enabled to secondary electronically controlled access 50 via electronically controlled switch 180. In the event that the site number and secondary RWD 30 ID do not match the site number and authorized RWD ID list on the particular contactless smart card 60, access is denied. In stage 1020, the access event of stage 1010 is stored on memory 160, preferably including the date/time stamp input from the date/time clock 130, as well as an indication of whether the access event was enabled or denied. In a preferred embodiment the access event is stored with the contactless smart card number, the type of event, the RWD number, the site number and the date/time stamp. Additionally, preferably the creation date/time stamp associated with the contactless smart card number are compared with a database in local memory 160 as will be described below in relation to FIG. 5B. In the event that no record of the contactless smart card is found on the database, the contactless smart card ID together with the creation date/time stamp is stored on the database.

In stage 1030, a predetermined number of most recent access events including the date/time stamp are copied from memory 160 to temporary storage location 220 of contactless smart card 60. Preferably, an ID of secondary RWD 30 is further copied to temporary storage location 220 associated with the list of access events. In one embodiment the last 10 access events are copied. Stage 1000 then again performed when an additional contactless smart card 60 is sensed within proximity of secondary RWD 30.

Thus, the operation of FIG. 3A enables access to authorized smart cards 60, stores the access event in memory 160 and copies a predetermined number of most recent access events to temporary storage area 220 of contactless smart card 60.

FIG. 3B illustrates a high level flow chart of the operation of primary RWD 20 of system 10 to download the transferred recent access events of FIG. 3A and a maintain a complete database of entry events in accordance with a principle of the invention. In stage 1500, primary RWD 20 senses a smart card within proximity thereof. In stage 1510, control circuitry 110 compares the contactless smart card ID, and in particular the site number and list of RWD IDs authorized for access, with the site number and ID of primary RWD 20. As described above, authorized ID numbers may be loaded directly into primary RWD 20, or transferred via a transfer card identified by transfer card identifier 260 being set.

In the event that the site number and primary RWD 20 ID match the site number and authorized RWD ID list on the particular contactless smart card 60, access is enabled to main electronically controlled access 40. In the event that that the site number and primary RWD 20 ID do not match the site number and authorized RWD ID list on the particular contactless smart card 60, access is denied. In stage 1520, the access event of stage 1510 is stored on memory 160, preferably including the date/time stamp input from the date/time clock 130, as well as an indication of whether the access event was enabled or denied. In a preferred embodiment the access event is stored with the contactless smart card number, the type of event, the RWD number, the site number and the date/time stamp.

In stage 1530, temporary storage area 220 of contactless smart card 60 is examined for an access events list as described above in relation to FIG. 3A. In the event that an access events list is found, in stage 1540 the list of access events and the ID of the secondary RWD 30 associated therewith is read from contactless smart card 60. In stage 1550, the access events list read in stage 1540 is stored on local memory 160 associated with the ID of the secondary RWD 30. Duplicate entries already received from a previous instance are identified and are not stored. In one embodiment, for each event of the event list, the ID of the secondary RWD is stored associated therewith. In another embodiment, the event list is stored associated with a single listing of the ID of the secondary RWD 30.

In the event that in stage 1530 no access events list is found, stage 1500 as described above is performed when another contactless smart card 60 is sensed in the proximity of primary RWD 20.

Thus, the method of FIG. 3B retrieves the stored events stack and stores it on local memory 160. Thus, local memory 160 of primary RWD 20 comprises a complete list of all access events within system 10. In an exemplary embodiment, the complete list of access events is periodically backed-up on data base storage 120.

FIG. 4A illustrates a high level flow chart of the operation of primary RWD 20 of system 10 to transfer clock update information to each secondary RWD 30 via smart cards in accordance with a principle of the invention. In stage 2000, a clock adjustment is input to date/time clock 130 of primary RWD 20. It is to be understood that primary RWD 20 is not connected by a network to any secondary RWD 30. Thus, prior art would require the clock adjustment to be manually transferred to each and every secondary RWD 30. In stage 2010, the time of date/time clock 130 is updated in accordance with the clock adjustment of stage 2000.

In stage 2020, a contactless smart card 60 is sensed in proximity of primary RWD 20. In stage 2030, control circuitry 110 compares an ID number read from contactless smart card 60 with a list of authorized ID numbers stored on database 120. In the event that the ID number read from contactless smart card 60 is found on the list of authorized ID numbers stored on database 120, access is enabled to main electronically controlled access 40. In the event that the ID number read from contactless smart card 60 is not found on the list of authorized ID numbers stored on database storage 120, access is denied. Preferably, as described above in relation to the FIG. 3B, the access event is further stored on database storage 120, preferably including the date/time stamp input from the date/time clock 130, as well as an indication of whether the access event was enabled or denied. In stage 2040, the time adjustment as input in stage 2000 is stored in the temporary storage area 220. In one embodiment, a flag is set indicating that temporary storage area 220 comprises a time adjustment. Preferably, the time adjustment is stored associated with the date/time stamp obtained from date/time clock 130.

Thus, the method of FIG. 4A adjusts the time of local date/time clock 130 of primary RWD 20, and stores adjustment information on contactless smart card 60. In an exemplary embodiment, the adjustment is in one hour increments reflecting a change to, or from, daylight savings time.

FIG. 4B illustrates a high level flow chart of the operation of secondary RWD 30 of the system 10 to receive clock update information from primary RWD 20 via a smart card and update the local date/time clock 130, in accordance with a principle of the invention. In stage 2500, control circuitry 150 of secondary RWD 30 senses a contactless smart card 60 within proximity thereof. In stage 2510 control circuitry 150 compares an ID number read from contactless smart card 60 with a list of authorized ID numbers stored on memory 160. In the event that the ID number read from contactless smart card 60 is found on the list of authorized ID numbers stored on memory 160, access is enabled to secondary electronically controlled access 50 via electronically controlled switch 180. In the event that the ID number read from contactless smart card 60 is not found on the list of authorized ID numbers stored on memory 160, access is denied. Preferably the access event is stored on memory 160, preferably including the date/time stamp input from the date/time clock 130, as well as an indication of whether the access event was enabled or denied.

In stage 2520, temporary storage area 220 of contactless smart card 60 is examined to determine if it is loaded with a time adjustment as described above in relation to FIG. 4A. In the event that temporary storage area 220 is not loaded with a time adjustment, stage 2500 as described above is performed when a next contactless smart card 60 is sensed. In the event that temporary storage area 220 is loaded with the time adjustment, in stage 2530 a time record indicative of the date/time stamp of the last time adjustment is checked. In the event that the time record of the last time adjustment occurred less than a predetermined minimum amount of time before the current date/time, stage 2500 as described above is again performed when they another contactless smart card 60 is sensed. Thus, repetitive clock adjustments are avoided.

In the event that the time record of the last time adjustment occurred more than a predetermined minimum amount of time before the current date/time, in stage 2540 the time adjustment is read temporary storage area 220. In stage 2550 date/time clock 130 is adjusted in accordance with the time adjustment read in stage 2540. In stage 2560, a time record indicative of the date/time stamp of the current time adjustment is stored as described above in relation to stage 2530. Stage 2500 is then again performed when an additional contactless smart card 60 is sensed.

The above has been described in an embodiment in which the time adjustment is stored in temporary storage area 220, however this is not meant to be limiting in any way. In one embodiment the time adjustment is stored in general memory 210 without exceeding the scope of the invention. Time adjustment 220 may be optionally erased by primary RWD 20 after a predetermined time interval sufficient to ensure that all secondary RWDs 30 have been updated.

Thus, the method of FIG. 4B transfers a clock adjustment from primary RWD 20 to secondary RWD 30 via contactless smart card 60 contemporaneously with access events. There is no requirement that a user input a clock adjustment to each of the secondary RWDs 30, as the method transfers the clock adjustment during normal operation of system 10.

FIG. 5A illustrates a high level flow chart of the operation of primary RWD 20 of system 10 to authorize access and date/time stamp each smart card in accordance with a principle of the invention. In stage 3000, primary RWD 20 senses a contactless smart card 60 within proximity thereof. In stage 3010, responds to this sensed contactless smart card 60 by enabling access to main electronically controlled access 40. In particular, and as described above, control circuitry 110 compares an ID number read from contactless smart card 60 with a list of authorized ID numbers stored on database 120. In the event that the ID number read from contactless smart card 60 is found on the list of authorized ID numbers stored on database 120, access is enabled to main electronically controlled access 40. Preferably, the access event is stored on database storage 120, preferably including the date/time stamp input from the date/time clock 130, as well as an indication of whether the access event was enabled or denied. In stage 3020, the date/time stamp obtained from date/time clock 130 and an ID of primary RWD 20 are stored on temporary storage area 220 of contactless smart card 60. Stage 3000 is again performed when primary RWD 20 senses an additional contactless smart card 60 in proximity.

Thus, the method of FIG. 5A stores the date/time stamp of enabled access by primary RWD 20 on contactless smart card 60. In certain high security areas, as will be described below in relation to FIG. 5B, access is restricted to be within a predetermined amount of time from access through primary RWD 20. Additionally the method of FIG. 5A further enables identifying a lost contactless smart card 60 which has been replaced, as will be described further hereinto below in relation to FIG. 5B.

FIG. 5B illustrates a high level flow chart of the operation of secondary RWD 30 of system 10 to control access responsive to the stored time stamp of FIG. 5A in accordance with a principle of the invention. A plurality of optional security measured are described which may be used in any combination without exceeding the scope of the invention.

In stage 3500, control circuitry 150 of secondary RWD 30 senses a contactless smart card 60 within proximity thereof. In stage 3510 control circuitry 150 reads the contactless smart card ID, and in particular the site number, list of authorized RWD IDs and contactless smart card number. In stage 3520, the date/time stamp of access at the primary RWD 20, along with the ID of primary RWD 20 is input.

In stage 3550 control circuitry 150 compares the ID of the primary RWD 20 input in stage 3520 with a list of authorized primary RWDs 20 stored on memory 60. Authorized primary RWD 20 ID numbers may be loaded directly into secondary RWD 30, or transferred via a transfer card identified by transfer card identifier 260 being set.

In the event that the primary RWD 20 ID number is not found on the list of authorized primary RWDs 20, in stage 3560 access is denied, and the denied access is stored in the access event list of memory 160. Stage 3500 is again performed when secondary RWD 30 senses an additional contactless smart card 60 in proximity.

Thus, the combination of stages 3550 and 3560 represent an optional additional security measure ensuring that access to secondary electronically controlled access 50 only occurs after authorized access to main electronically controlled access 40. In an exemplary embodiment, certain primary RWDs 20 are manned by trained security personnel thus ensuring a higher level of security.

In the event that in stage 3550 the primary RWD 20 ID number is found on the list of authorized primary RWDs 20, in stage for 3570 the time interval between the current time as indicated by date/time clock 130 of secondary RWD 30 and the date/time stamp input in stage 3520 is compared to a maximum allowed time lapse. In the event that the time lapse is greater than the maximum allowed time, in stage 3580 access is denied, and the denied access is stored in the access event list of memory 160. Stage 3500 is again performed when secondary RWD 30 senses an additional contactless smart card 60 in proximity.

Thus, the combination of stages 3570 and 3580 represent an optional additional security measure ensuring that access to secondary electronically controlled access 50 only occurs within a predetermined time after authorized access to main electronically controlled access 40. In an exemplary embodiment, access during off hours to secondary electronically controlled access 50 is thus restricted by the operation of a controlled primary RWD 20.

In one embodiment the maximum allowed time lapse for each secondary RWD 30 is set through a configuration card. Thus, by the use of a plurality of configuration cards, each secondary RWD 30 is settable to a particular maximum allowed time interval, and the system is not constrained to a single maximum time interval.

In the event that in stage 3570 the time lapse is not greater than the maximum allowed time, in stage 3590 single access identifier 280 is examined. In the event that single access identifier 280 is set, thus indicative that only a single access is to be allowed by secondary RWD 30 within a predetermined time interval, in stage 3600 the time interval from the last access of the smart card identified in stage 3500, 3510 is compared to a predetermined time interval. In the event that the time interval is less than a minimum predetermined time interval, in stage 3610 access is denied, and the denied access is stored in the access event list of memory 160. Stage 3500 is again performed when secondary RWD 30 senses an additional contactless smart card 60 in proximity.

Thus, the combination of stages 3590-3610 represent an optional additional security measure ensuring that access to secondary electronically controlled access 50 only occurs a single time within a predetermined time interval. Access is thus carefully controlled, and a misplaced contactless smart card 60 becomes immediately unusable.

In the event that in stage 3600 the time interval is not less than a minimum predetermined time interval, in stage 3620 control circuitry 150 compares the ID number read from contactless smart card 60 in stage 3510 with a list of authorized ID numbers stored on memory 160. In the event that the ID number read from contactless smart card 60 is found on the list of authorized ID numbers stored on memory 160, access is enabled to secondary electronically controlled access 50 via electronically controlled switch 180. In the event that the ID number read from contactless smart card 60 is not found on the list of authorized ID numbers stored on memory 160, access is denied. The access event, including the date/time stamp input from the date/time clock 130 is stored on memory 160, as well as an indication of whether the access event was enabled or denied. Stage 3500 is again performed when secondary RWD 30 senses an additional contactless smart card 60 in proximity.

FIG. 5C illustrates a high level flow chart of the operation of both the primary RWD 20 and secondary RWDs 30 of system 10 to control access and identify a lost smart card responsive to a creation date/time stamp. In stage 4000, control circuitry 150 of secondary RWD 30, or control circuitry 110 of primary RWD 20, respectively, senses a contactless smart card 60 within proximity thereof. In stage 4010 control circuitry 150 of secondary RWD 30, or control circuitry 110 of primary RWD 20, respectively, inputs the contactless smart card ID, and in particular the site number, list of authorized RWD IDs and contactless smart card number. In stage 4020, the creation date/time stamp of contactless smart card 60 is input.

In stage 4030, the creation date/time stamp input in stage 4020 is compared with a stored creation date/time stamp associated with the smart card ID input in stage 4010 stored on a control database of memory 160. In an exemplary embodiment, each smart card, when lost or replaced, is created with the same ID number and stamped with the creation date/time stamp.

In the event that the creation date/time stamp input in stage 4020 is older than the creation date/time stamp associated with the smart card ID found on the control database, in stage 4040 contactless smart card 60 is identified as a lost contactless smart card 60 which has been replaced. Access is denied, and the denied access is stored in the access event list of memory 160. In one embodiment a flag indicative that contactless smart card 60 is to be disregarded is stored in a predetermined memory location of contactless smart card 60. Stage 4000 is again performed when secondary RWD 30 or primary RWD 20 senses an additional contactless smart card 60 in proximity.

In the event that in stage 4030 the creation date/time stamp input in stage 4020 is not older than the creation date/time stamp associated with the smart card ID found on the control database, in stage 4050 the creation date/time stamp input in stage 4020 is again compared with the stored creation date/time stamp associated with the smart card ID input in stage 4010 stored on the control database of memory 160. In the event that the creation date/time stamp input in stage 4020 is newer than the creation date/time stamp associated with the smart card ID found on the control database, in stage 4060 the control database is updated with the new creation date/time stamp. In the event that the smart card ID is not stored on the local database, stage 4060 is similarly performed to load the smart card ID associated with the creation date/time stamp. Stage 4000 is again performed when secondary RWD 30 or primary RWD 20 senses an additional contactless smart card 60 in proximity.

In the event that in stage 4050 the creation date/time stamp input in stage 4020 is not newer than the creation date/time stamp associated with the smart card ID found on the control database, i.e. the date/time stamps are the same, stage 4000 is again performed when secondary RWD 30 or primary RWD 20 senses an additional contactless smart card 60 in proximity

Thus, the method of FIG. 5C represents an optional routine to identify a lost and replaced contactless smart card 60 responsive to a creation date/time stamp.

Thus the present embodiments enable an improved access control system by storing transfer information on each of the contactless smart cards as the contactless smart card is placed in proximity of the RWD. In one embodiment, each secondary RWD maintains a local stack of historical access events. Each contactless smart card, when placed in proximity of a secondary RWD is loaded with a pre-determined number of most recent historical events, and an identifier of the secondary RWD. When the contactless smart card is placed in proximity of the primary RWD, the historical access events and the identifier of the secondary RWD which was the source of the access events, is loaded to the primary RWD. The access event memory is then erased from the contactless smart card. The primary RWD, in cooperation with the identifier of the secondary RWD, prevents duplication of records, and thus stores a complete event listing of all RWDs in the system. In one embodiment the primary RWD stores the complete event listing locally, and in another embodiment the complete event listing is stored on a connected database. In yet another embodiment the primary RWD uploads data for permanent remote storage via a dedicated transfer contactless smart card or portable computer.

In another embodiment, which finds particular advantage during the change to, or from, daylight savings time, in the event of a change in time at the primary RWD, each contactless smart card when placed in proximity to the primary RWD for a predetermined time period is loaded with information to adjust the clock by a particular amount of time. When the contactless smart card is placed in proximity of any of the secondary RWDs, the secondary RWD reads the time adjustment, and adjusts its internal clock accordingly.

In another embodiment, security is enhanced by time stamping the contactless smart card when it is in proximity to the main RWD. Access to secondary RWDs are restricted to being with a predetermined time period of the time stamp. Thus, in the event of a lost contactless smart card, access will be denied.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. An access control system comprising:
a primary contactless read write device;
at least one secondary contactless read write device; and
a plurality of smart cards configured for use with said primary contactless read write device and said at least one secondary contactless read write device, said plurality of smart cards being further configured to exhibit a temporary storage space for use by one of said primary contactless read write device and said at least one secondary contactless read write device.

2. An access control system according to claim 1, wherein each of said at least one secondary contactless read write devices comprises a read write interface, a clock, a memory and a control circuitry, said control circuitry being operative to:
record access events on said memory associated with an event time read from said clock; and
in the event one of said plurality of smart cards is within proximity of said at least one secondary contactless read write device, copy a predetermined number of most recent access events to said one smart card.

3. An access control system according to claim 2, wherein said primary contactless read write device comprises a system access event database and a control circuitry, said control circuitry being operative in the event that said one smart card is within proximity to:
read said copied access events from said one smart card;
store said copied access events to said event database; and
erase said access events from said one smart card.

4. An access control system according to claim 1, wherein said primary contactless read write device comprises a control circuitry and a settable clock, and wherein in the event of a time adjustment to said settable clock, said control circuitry is operative to store a time change command on at least one of said plurality of smart cards when said at least one of said plurality of smart cards is within proximity of said primary contactless read write device.

5. An access control system according to claim 4, wherein said at least one secondary contactless read write device comprises a settable clock and a control circuitry, said control circuitry being operative to:
sense one of said plurality of smart cards within proximity thereof;
responsive to said sensed proximity, read said stored time change command from said one of said plurality of smart cards; and
set said settable clock responsive to said read stored time change command.

6. An access control system according to claim 1, wherein said primary contactless read write device comprises:
a control circuitry;
a contactless read write interface responsive to said control circuitry; and
a clock in communication with said control circuitry,
said control circuitry being operative to:
sense one of said plurality of smart cards within proximity of said primary contactless read write device;
input a current time indicator from said clock; and
store said input current time indicator on said temporary storage space of said one of said plurality of smart cards.

7. An access control system according to claim 6, wherein said at least one secondary contactless read write device comprises:
a control circuitry;
a contactless read write interface responsive to said control circuitry; and
a local clock in communication with said control circuitry, said local clock operative to output a time indicator,
said control circuitry being operative to:
sense one of said plurality of smart cards within proximity of said primary contactless read write device;
input said stored current time indicator from said temporary storage space;
compare said input stored time indicator with a local time indicator output from said local clock; and
in the event said input stored time indicator is different from said local time indicator by more than a predetermined amount, deny access to said sensed one of said plurality of smart cards.

8. An access control system according to claim 7, wherein said control circuitry of said at least one secondary contactless read write device is further operative to:
in the event said input stored time indicator is not different from said local time indicator by more than a predetermined amount, enable access to said sensed one of said plurality of smart cards.

9. An access control system according to claim 8, wherein said at least one secondary contactless read write device further comprises an access control circuitry operative to enable access to an area.

10. An access control system according to claim 6, wherein said stored time indicator comprises a date and a time, said time indicator of said local clock further comprising a date and time, and wherein said comparison of said input stored time indicator with a local time indicator output from said local clock comprises both date and time.

11. An access control system according to claim 1, wherein said plurality of smart cards are each encoded with a creation date/time stamp and an identification number, said primary contactless read write device and said at least one contactless read write device further comprising a control database and being operative, in the event that one of said plurality of smart cards is within proximity, to:
input said identification number and said creation date/time stamp,
compare a stored creation date/time stamp associated with said identification number found on said control database with said input creation date/time stamp, and in the event that said input creation date/time stamp is older than said stored creation date/time stamp, deny access.

12. A method of data transfer comprising:
providing a primary read write device;
providing at least one secondary read write device;
providing at least one smart card;
storing an information datum on a first one of said provided primary read write device and said provided at least one secondary read write device;
transferring said stored information datum to said at least one smart card; and
transferring said information datum from said at least one smart card to a second one of said of said provided primary read write device and said provided at least one secondary read write device, said second one being different than said first one.

13. A method according to claim 12, wherein said information datum is a record of an access event.

14. A method according to claim 12, wherein said information datum is a clock adjustment.

15. A method according to claim 14, wherein said information is stored on said provided primary read write device, said method further comprising:
updating a clock of said at least one secondary read write device by said transferred clock adjustment.

16. A method according to claim 14, wherein said information is stored on said provided primary read write device, said method further comprising:
determining an elapsed time since a last clock adjustment; and
updating, only in the event said elapsed time is greater than a predetermined amount of time, a clock of said at least one secondary read write device by said transferred clock adjustment.

17. A method of access control comprising:
providing one of a primary read write device and a secondary read write device;
providing a smart card with a unique identifier and a creation date/time stamp;
reading, at said one of a primary read write device and a secondary read write device, said creation date/time stamp;
comparing said read creation date/time stamp with a stored creation date/time stamp associated with said unique identifier; and
denying access to said provided smart card in the event said input creation date/time stamp is earlier than said stored creation date/time stamp associated with said unique identifier.

18. A method according to claim 17, further comprising:
recording, by said provided primary read write device, on said provided smart card an identifier of said primary read write device;
reading, by said provided at least one secondary read write device, said recorded identifier of said primary read write device;
comparing said read recorded identifier with a list of authorized identifiers; and
denying access, in the event said recorded identifier is not on said list of authorized identifiers, to said provided smart card.

19. A method according to claim 17, further comprising:
comparing said recorded time stamp with a current time; and
denying access, in the event the difference between said recorded time stamp and said current time is greater than a predetermined maximum time interval, to said provided smart card.

20. A method according to claim 17, further comprising:
setting an identifier on said provided smart card of a single access authorization;
comparing said time stamp of said last recorded access event associated with said unique identifier with a current time; and
denying access, in the event a difference between said time stamp of said last recorded access event associated with said unique identifier and said current time is less than a predetermined minimum time, to said provided smart card.
